(19) United States
(12) Patent Application Publication
(10) Pub. No.: US 2016/0370574 A1
(43) Pub. Date: Dec. 22, 2016

(54) DISPLAY DEVICE AND METHOD OF DRIVING THE SAME

(71) Applicant: SAMSUNG DISPLAY CO., LTD., Yongin-si (KR)

(72) Inventors: Joo-Woan CHO, Seongnam-si (KR); In-Sun HWANG, Suwon-si (KR)

(21) Appl. No.: 15/014,824

(22) Filed: Feb. 3, 2016

(30) Foreign Application Priority Data
Jun. 17, 2015 (KR) 10-2015-0085600

(51) Int. Cl. G02B 26/00

(52) U.S. Cl. CPC G02B 26/005

(57) ABSTRACT

A display device may include a plurality of pixels including a display area and a transparent area, and a shielding member corresponding to the transparent area of each of the plurality of pixels. The shielding member may have a light shutter, a light shutter line electrically connected to the light shutter and disposed adjacent to the plurality of pixels, and a wall surrounding the light shutter. Light transmittance of light incident into the transparent area is controlled by the shielding member.

### CROSS-REFERENCE TO RELATED APPLICATION(S)

This application claims priority under 35 USC §119 to and benefits of Korean Patent Application No. 10-2015-0085600, filed on Jun. 17, 2015 in the Korean Intellectual Property Office (KIPO), the disclosure of which is incorporated herein by reference in its entirety.

### BACKGROUND

1. Field

The present disclosure relates to display devices and methods of driving the same. More particularly, the present disclosure relates to transparent display devices including a transparent area and methods of driving the same.

2. Description of the Related Art

Display devices has been used as information delivery media. A demand for the display devices has increased recently with the popularity of televisions, computers, tablets, and smartphones. A conventional display device has an opaque screen that displays images to one direction. Recently, a transparent display device including a transparent area and capable of transmitting an image of an object (or a target) located on the bottom of the display device in the transparent area has been developed.

In general, pixels included in the transparent display device have a display area and a transparent area, and an object located on the bottom of the display device may be seen by light incident into the transparent area that is adjacent to the display area.

However, due to the transparency of the transparent area of the transparent display device, an image of the display area may be distorted, and a user may not clearly recognize the image of the display area. In addition, when the background of the bottom of the transparent display device is brighter than a screen of the transparent display device, the image of the display area may be invisible.

### SUMMARY

The present disclosure provides a display device selectively transmitting, substantially blocking, or partially blocking incident light, and a method of driving the same.

According to one embodiment, the display device includes a plurality of pixels and a shielding member. The pixel includes a display area and a transparent area. The shielding member has a light shutter, a light shutter line electrically connected to the light shutter and disposed adjacent to the plurality of pixels, and a wall surrounding the light shutter. The shielding member corresponds to the transparent area of each of the plurality of pixels. Light transmittance of light incident into the transparent area is controlled by the shielding member.

In one embodiment, the light shutter may include a lower substrate, a lower electrode disposed on the lower substrate, an insulating layer disposed on the lower electrode, an upper substrate opposing the lower substrate, an upper electrode disposed on a lower surface of the upper substrate, and an organic solution and an aqueous solution interposed between the lower electrode and the upper electrode.

In one embodiment, the organic solution may include a reflective material.

In one embodiment, the light shutter may transmit, substantially block, or partially block the light incident into the transparent area of each of the plurality of pixels.

In one embodiment, the light shutter may transmit the light incident into the transparent area when the display device operates in a transmissive mode.

In one embodiment, the light shutter may substantially block the light incident into the transparent area when the display device operates in a blocking mode.

In one embodiment, the light shutter may partially block the light incident into the transparent area when the display device operates in a transflective mode.

In one embodiment, the display device may further include a first substrate and a second substrate opposing the first substrate. The light shutter may be interposed between the first and second substrates.

In one embodiment, the display device may further include a first substrate and a second substrate opposing the first substrate. The light shutter may be disposed outside of the first substrate or the second substrate.

In one embodiment, the light shutter may overlap both the transparent area and the display area.

In one embodiment, the light shutter may be disposed on a bottom of each of the plurality of pixels.

In one embodiment the light shutter may be disposed on a top of each of the plurality of pixels.

In one embodiment, one side surface of the wall may be hydrophobic.

In one embodiment, the one side surface of the wall may be disposed adjacent to the display area.

In one embodiment, one side edge of the wall may be hydrophobic.

In one embodiment, the one side edge of the wall may be disposed adjacent to the display area.

According to one embodiment, a method of driving a display device comprising a plurality of pixels including a display area and a transparent area, and a shielding member having a light shutter, a light shutter line electrically connected to the light shutter and disposed adjacent to the plurality of pixels, and a wall surrounding the light shutter, the shielding member corresponding to the transparent area of each of the plurality of pixels, the method includes applying a first voltage, a second voltage that is less than the first voltage, or a third voltage that is greater than the second voltage and less than the first voltage to the light shutter to selectively transmit, substantially block, or partially block light incident into the transparent area; and operating the light shutter in a transmissive mode, a blocking mode, or a transflective mode.

In one embodiment, the first voltage may be applied to the light shutter via the light shutter line to transmit the light incident into the transparent area when the light shutter operates in the transmissive mode.

In one embodiment, the second voltage may be applied to the light shutter via the light shutter line to substantially block the light incident into the transparent area when the light shutter operates in the blocking mode.

In one embodiment, the third voltage may be applied to the light shutter via the light shutter line to partially block the light incident into the transparent area when the light shutter operates in the transflective mode.

In the display device according to one embodiment, the light shutter may transmit, substantially block, or partially block light incident into the transparent area by using an electrowetting effect. For example, in the transparent mode, an object located on the bottom of the display device may be visible, and an image of the display area may be shared with another user on the other side. Also, in the blocking mode, the display device may operate as an opaque display device. Moreover, since transmittance of the light incident into the transparent area may be controllable based on the voltage applied to the light shutter, the display device may function as a display device with controllable light transmittance.

### BRIEF DESCRIPTION OF THE DRAWINGS

Illustrative, non-limiting embodiments will be more clearly understood from the following detailed description taken in conjunction with the accompanying drawings.

FIG. 1 is a planar view illustrating a display device in accordance with one embodiment.

FIGS. 2A and 2B are cross-sectional views explaining an operation of a light shutter in accordance with one embodiment.

FIG. 3 is a cross-sectional view illustrating a light shutter in accordance with one embodiment.

FIG. 4 is a cross-sectional view illustrating a driving a light shutter in a transmissive mode in accordance with one embodiment.

FIG. 5 is a cross-sectional view illustrating a driving a light shutter in a blocking mode in accordance with one embodiment.

FIG. 6 is a cross-sectional view illustrating a driving a light shutter in a transflective mode in accordance with one embodiment.

FIG. 7 is a cross-sectional view illustrating a display device in accordance with one embodiment.

FIG. 8 is a cross-sectional view illustrating a display device in accordance with one embodiment.

FIG. 9 is a cross-sectional view illustrating a display device in accordance with one embodiment.

FIGS. 10 and 11 are planar views illustrating a display device in accordance with one embodiment.

FIG. 12 is a cross-sectional view explaining a method of driving a display device in a transmissive mode in accordance with one embodiment.

FIG. 13 is a cross-sectional view explaining a method of driving a display device in a blocking mode in accordance with one embodiment.

FIG. 14 is a cross-sectional view explaining a method of driving a display device in a transflective mode in accordance with one embodiment.

### DETAILED DESCRIPTION OF THE EMBODIMENTS

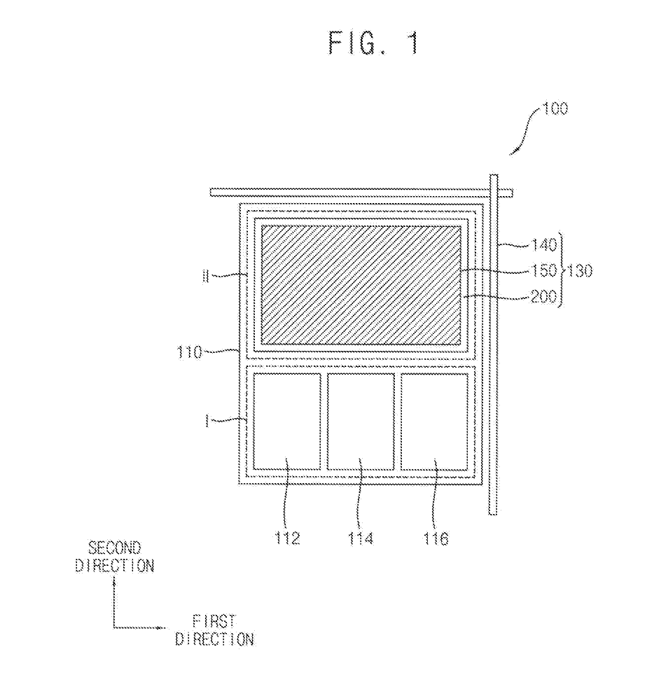

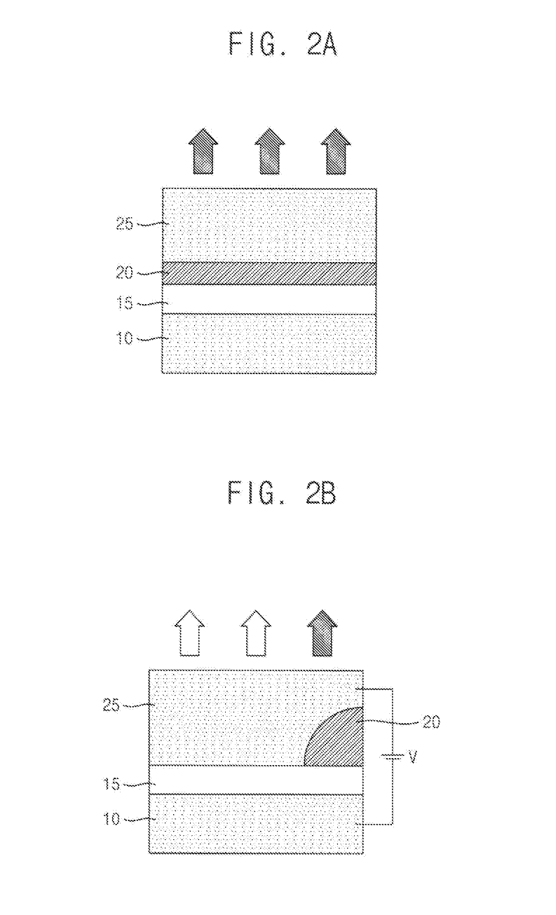

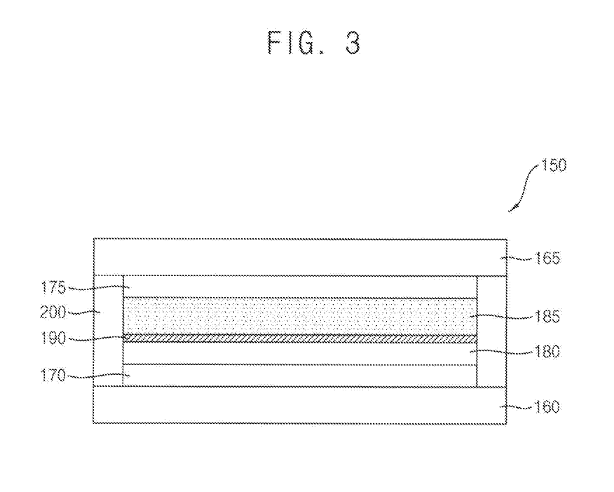

Hereinafter, some embodiments will be explained in detail with reference to the accompanying drawings. FIG. 1 is a planar view illustrating a display device in accordance with one embodiment. FIGS. 2A and 2B are cross-sectional views explaining an operation of a light shutter in accordance with one embodiment. FIG. 3 is a cross-sectional view illustrating a light shutter in accordance with one embodiment.

Referring to FIGS. 1 and 3, the display device 100 includes a plurality of pixels 110 and shielding members 130 that are disposed on a substrate. Each of the pixels 110 includes a display area I and a transparent area II. For example, the pixels 110 may be substantially arranged in a matrix form on the substrate.

Each pixel 110 includes a plurality of sub-pixels 112, 114, and 116 disposed on the display area I. Although three sub-pixels 112, 114, and 116 are substantially arranged in a stripe form in the FIG. 1, the arrangement of the pixel 110 is not limited thereto. For example, more than three sub-pixels may be arranged on the display area I, or the plurality of the sub-pixels may be arranged in a pentile matrix form.

In one embodiment, the pixel 110 may include a red sub-pixel 112, a green sub-pixel 114, and a blue sub-pixel 116. The red, green, and blue sub-pixels 112, 114, and 116 may be substantially uniformly arranged on the display area I along a first direction. The display area I may display an image by using a red light, a green light, and a blue light emitted from the red, green, and blue sub-pixels 112, 114, and 116 each.

As illustrated in FIG. 1, the sub-pixels 112, 114, and 116 are not disposed on the transparent area II and light incident into the transparent area II may pass through the transparent area II, therefore an object located on the bottom of the display device 100 may be seen through the transparent area II. In one embodiment, the transparent area II may be disposed adjacent to the display area I in a second direction substantially perpendicular to the first direction. The transparent area II may have a substantially rectangular shape, however, a shape of the transparent area II is not limited thereto. For example, the transparent area II may have various shapes such as a substantially oval shape, a substantially circular shape, a substantially polygonal shape, etc. A transmittance of the display device 100 may change according to a size of the transparent area II. Since light incident into the bottom of the display device 100 may pass through the transparent area II, a user may recognize the object located on the bottom of the display device 100.

The shielding member 130 includes a light shutter 150, a light shutter line 140, and a wall 200. According to one embodiment, the light shutter 150 uses an electrowetting effect to selectively transmit or block incident light. The electrowetting effect changes of an contact angle and an interfacial shape of a fluid according to a change of a surface tension of the fluid when an electric field is applied to a surface of the fluid. In general, the contact angle of a droplet of the fluid on a hydrophobic solid surface changes according to a voltage applied to the droplet. When a hydrophilic droplet is on the hydrophobic solid surface, the droplet may have a substantially spheral shape. When a voltage is applied, the solid surface changes from hydrophobic to hydrophilic, and a contact area between the droplet and the solid surface increases.

Referring to FIG. 2A, a mixed layer including an organic solution 20 and an aqueous solution 25 is disposed on an insulating layer 15 located on an electrode 10. Since an addition of an interfacial energy between the organic solution 20 and an aqueous solution 25 to an interfacial energy between the organic solution 20 and the insulating layer 15 is less than an interfacial energy between the aqueous solution 25 and the insulating layer 15, the organic solution 20 may substantially cover the insulating layer 15, and the aqueous solution 25 may be disposed on the organic solution 20. Consequently, light incident through the electrode 10 and the insulating layer 15 may be blocked by the organic solution 20.

Referring to FIG. 2B, a voltage is applied between the aqueous solution 25 and the electrode 10. The insulating layer 15 changes from hydrophobic to hydrophilic, and a contact area between the aqueous solution 25 and the insulating layer 15 may increase. Consequently, the light incident through the electrode 10 and the insulating layer 15 may pass through the aqueous solution 25.

In the light shutter 150 shown in FIG. 1, the voltage applied between the aqueous solution 25 and the insulating layer 15 changes a covering area of the aqueous solution 25 and the organic solution 20 on the insulating layer 15 to control an amount of the light passing through the light shutter 150. The shielding member 130 includes the light shutter 150, the light shutter line 140, and the wall 200. The light shutter 150 may substantially or partially block light incident into the transparent area II of the pixel 110 based on a signal applied through the light shutter line 140. According to one embodiment, a plurality of the shielding members 130 may be disposed on the transparent areas II of the pixels 110, and light incident into the display device 100 may be substantially or partially blocked by the plurality of the shielding members 130.

In one embodiment, the light shutter 150 of the shielding member 130 transmits or at least partially blocks the light incident into the transparent area II of the display device 100. The light shutter 150 may be disposed on the transparent area II of the pixel 110, but the disposition of the light shutter 150 is not limited thereto.

The light shutter line 140 may be disposed adjacent to the pixels 110 and electrically connected to the light shutter 150. The light shutter line 140 transfers a control signal to the light shutter 150 to control the light transmittance of the light shutter 150. The light shutter 150 transmits or blocks the incident light based on the signal from the light shutter line 140. The light shutter line 140 may be disposed along the first direction and the second direction adjacent to data voltage lines and/or gate voltage lines that transfer signals to control the pixels 110.

The wall 200 substantially surrounds the light shutter 150. The wall 200 may prevent leakages of material from the light shutter 150 and contaminations of the light shutter 150.

The shielding member 130 may further include a light shutter driving circuit. The light shutter driving circuit transfers the control signal to the light shutter 150 through the light shutter line 140 based on an input from a user to control light transmittance of the light shutter 150.

Referring to FIG. 3, the light shutter 150 includes a lower substrate 160, an upper substrate 165, a lower electrode 170, an upper electrode 175, an insulating layer 180, an aqueous solution 185, and an organic solution 190. The light shutter 150 may transmit or block the incident light by using an electrowetting effect. The lower substrate 160 and the upper substrate 165 are spaced apart from each other by a predetermined distance. The lower and upper substrates 160 and 165 may include a glass substrate or a resin substrate.

The lower electrode 170 is disposed on the lower substrate 160. A voltage may be applied to the lower electrode 170 from the light shutter line 140. The upper electrode 175 is disposed on a lower surface of the upper substrate 165 to correspond to the lower electrode 170. The upper electrode 175 may transfer a voltage from the light shutter line 140 to the aqueous solution 185. The lower electrode 170 and the upper electrode 175 may include a transparent conductive material to transmit incident light. For example, the lower electrode 170 and the upper electrode 175 may include indium tin oxide (ITO), indium zinc oxide (IZO), indium tin zinc oxide (ITZO), zinc oxide (ZnO), etc.

The insulating layer 180 is disposed on the lower electrode 170. The insulating layer 180 may include transparent material having a hydrophobic surface. For example, the insulating layer 180 may include an organic material such as fluoropolymer, parylene, etc. In another example, the insulating layer 180 may include an inorganic material such as silicon oxide (SiOx), barium strontium titanate (BST), etc. When the insulating layer 180 includes the inorganic material, an organic material may be coated on a surface of the insulating layer 180 to make the surface of the insulating layer 180 to be hydrophobic.

A mixed layer including the aqueous solution 185 and the organic solution 190 is interposed between the upper electrode 175 and the insulating layer 180. For example, distilled water or electrolyte dissolved aqueous solution may be used as the aqueous solution 185. The organic solution 190 may be hydrophobic to use the electrowetting effect. The organic solution 190 may include an inorganic material or an organic material to block the incident light. The inorganic material contained in the organic solution 190 may include black carbon, and the organic material contained in the organic solution 190 may include an organic dye, an organic pigment, etc. In one embodiment, the organic solution 190 may include reflective material to reflect the incident light. For example, the reflective material may include titanium oxide (TiOₓ), barium sulfate (BaSO₄), glass bead, etc. When the organic solution 190 includes the reflective material, the organic solution 190 may not only reflect but also block the incident light. In this case, the display device 100 may function as a mirror display device.

The wall 200 is disposed on sides of the lower substrate 160 and the upper substrate 165 to substantially surround the light shutter 150. The wall 200 is interposed between the upper substrate 165 and the lower substrate 160. The wall 200 may prevent leakages of the aqueous solution 185 and the organic solution 190 from the light shutter 150. The wall 200 may also prevent contaminations of the aqueous solution 185 and the organic solution 190 from external materials. In one embodiment, instead of being interposed between the lower substrate 160 and the upper substrate 165 as shown in FIG. 3, the wall 200 may substantially surround the sides of the lower substrate 160 and the upper substrate 165.

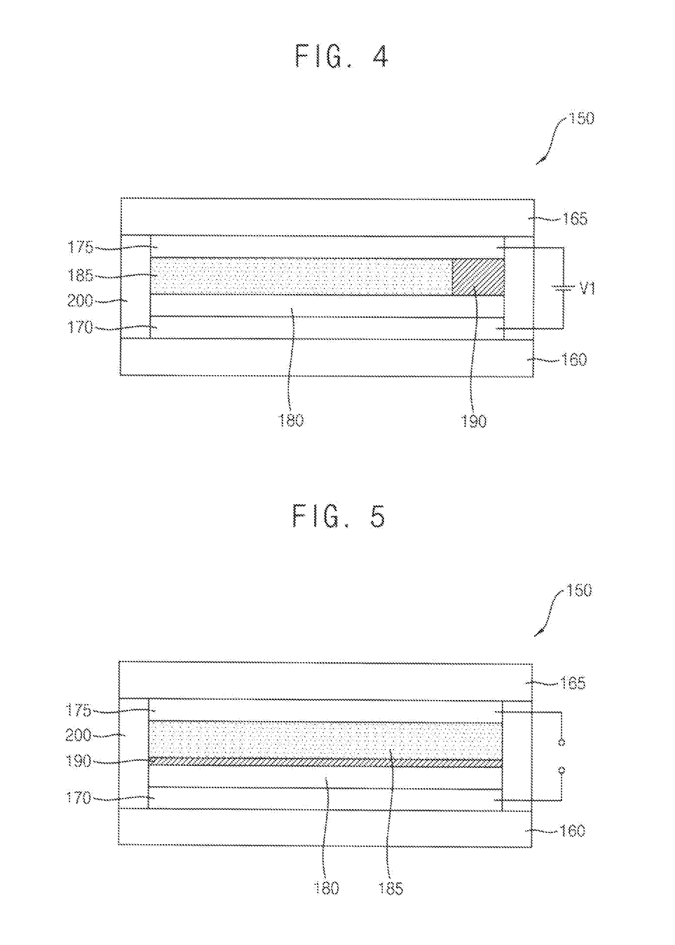

FIG. 4 is a cross-sectional view illustrating a driving a light shutter in a transmissive mode in accordance with one embodiment. FIG. 5 is a cross-sectional view illustrating a driving a light shutter in a blocking mode in accordance with one embodiment.

In one embodiment, the light shutter 150 may substantially transmit or block light incident into the transparent area II of the pixel 110. The display device 100 may serve as a transparent display device when the light shutter 150 transmits the light incident into the transparent area II. On the contrary, the display device 100 may serve as an opaque display device when the light shutter 150 substantially blocks the light incident into the transparent area II.

Referring to FIG. 4, when the light shutter 150 operates in a transparent mode, the light incident into the transparent area II is transmitted, so that an object located on the bottom of the display device 100 can be seen. In the transparent mode of the light shutter 150, when a predetermined voltage V1 is applied between the lower electrode 170 and the upper electrode 175, a surface of the insulating layer 180 changes from hydrophobic to hydrophilic, and a contact area between the aqueous solution 185 and the insulating layer 180 increases. Therefore, the organic solution 190 may move to the wall 200 to which the voltage is not applied causing most of the transparent area II to be covered with the transparent aqueous solution 185.

Referring to FIG. 5, when the light shutter 150 operates in a blocking mode, the light incident into the transparent area II may be substantially blocked. In the blocking mode of the light shutter 150, when the voltage is not applied between the lower electrode 170 and the upper electrode 175, the surface of the insulating layer 180 changes back to hydrophobic from hydrophilic, and a contact area between the organic solution 190 and the insulating layer 180 increases. The aqueous solution 185 may move on the organic solution 190 causing most of the transparent area II to be covered with the opaque organic solution 190.

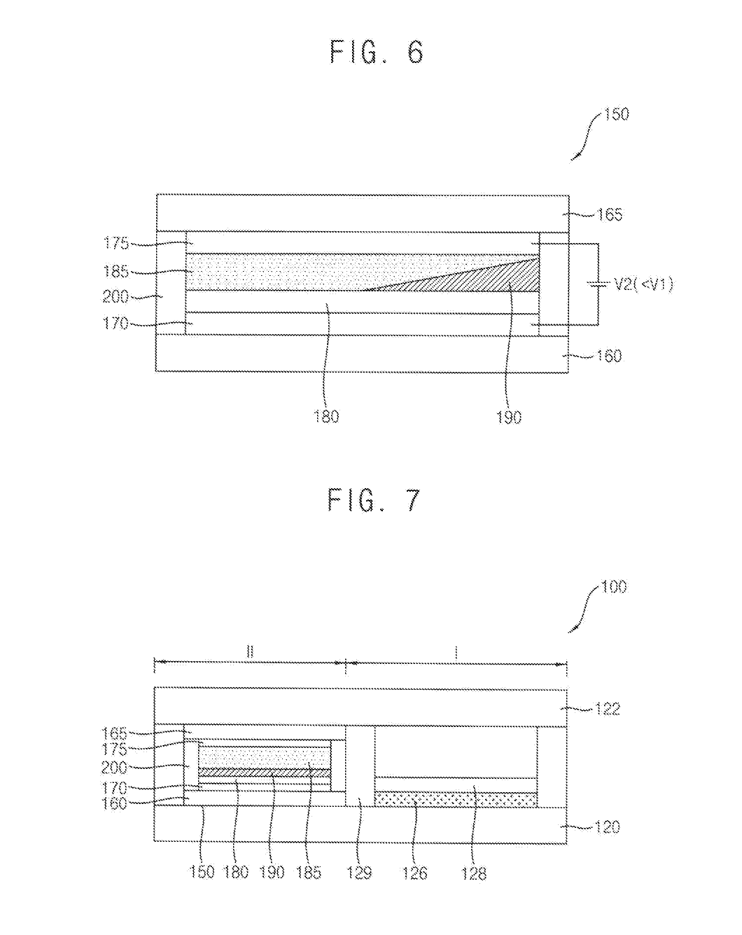

FIG. 6 is a cross-sectional view illustrating a driving a light shutter in a transflective mode in accordance with oneembodiment. In one embodiment, the light shutter 150 may partially transmit and partially block the light incident into the transparent area II of the pixel 110. The display device 100 may serve as a transparent display device of which light transmittance is controllable when the light shutter 150 partially blocks the light incident into the transparent area II. Referring to FIG. 6, when the light shutter 150 operates in a transflective mode, the light incident into the transparent area II may be partially blocked. In the transflective mode of the light shutter 150, a voltage V2 that is less than the voltage V1 of the transparent mode (as shown in FIG. 4) is applied between the lower electrode 170 and the upper electrode 175, and the surface of the insulating layer 180 changes from hydrophobic to relatively hydrophilic causing the contact area between the aqueous solution 185 and the insulating layer 180 to increase. However, the contact area may be less than the contact area in the transparent mode in which the voltage V1 is applied. Some of the organic solution 190 move to the wall 200 to which the voltage is not applied. A portion of the transparent area II is covered by the opaque organic solution 190, and the light is transmitted through uncovered area by the organic solution 190, so that the display device 100 operates in a transflective mode.

According to one embodiment, the light shutter 150 may transmit or block the light incident into the transparent area II by using the electrowetting effect. For example, in the transparent mode, the object located on the bottom of the display device 100 may be visible, and images of the display area I may be shared with another user on the other side. Also, in the blocking mode, the display device 100 may serve as the opaque display device. Moreover, since the light transmittance of the light incident into the transparent area II is controllable by the voltage applied to the light shutter 150, the display device 100 may function as the display device with controllable light transmittance.

FIG. 7 is a cross-sectional view illustrating a display device in accordance with one embodiment. Referring to FIG. 7, the display device 100 includes a first substrate 120, a second substrate 122, a pixel circuit 126, a light emitting structure 128, a pixel defining layer 129, and a shielding member having a light shutter 150. Although an organic light emitting display device is explained as an example of the display device 100, the display device 100 is not limited thereto, and other display devices such as a liquid crystal display device may be used as the display device 100.

The first substrate 120 and the second substrate 122 is separated over a prescribed distance. The first and second substrates 120 and 122 may include a glass substrate or a resin substrate. The pixel circuit 126 for driving the light emitting structure 128 is disposed on the display area I of the first substrate 120. The pixel circuit 126 is included in each sub-pixel. The pixel circuit 126 may include a driving transistor, a switching transistor, and a capacitor. For example, a voltage that is a difference between a data voltage and a reference voltage may be charged on the capacitor that is connected between a gate electrode and a source electrode of the driving transistor, and the driving transistor operates by the charged voltage.

The light emitting structure 128 is disposed on the pixel circuit 126. The light emitting structure 128 may emit light based on a signal inputted through the driving transistor to display an image. The pixel defining layer 129 is interposed between the first substrate 120 and the second substrate 122. The pixel defining layer 129 separates each pixel 110, and the each pixel 110 defines the display area I and the transparent area II. For example, the pixel defining layer 129 may substantially surround the display area I and the transparent area II.

In one embodiment, the light shutter 150 of the shielding member is interposed between the first substrate 120 and the second substrate 122 as an in-cell structure. For example, the light shutter 150 interposed between the first substrate 120 and the second substrate 122 may be surrounded by the wall 200 and the pixel defining layer 129. When the light shutter 150 is manufactured with the in-cell structure, a thickness of the display device 100 may be made to be thinner than that of a display device in which the light shutter 150 is disposed outside of the transparent area II. Since forming the light shutter 150 may be included in manufacturing the display device 100, additional expenses may be reduced.

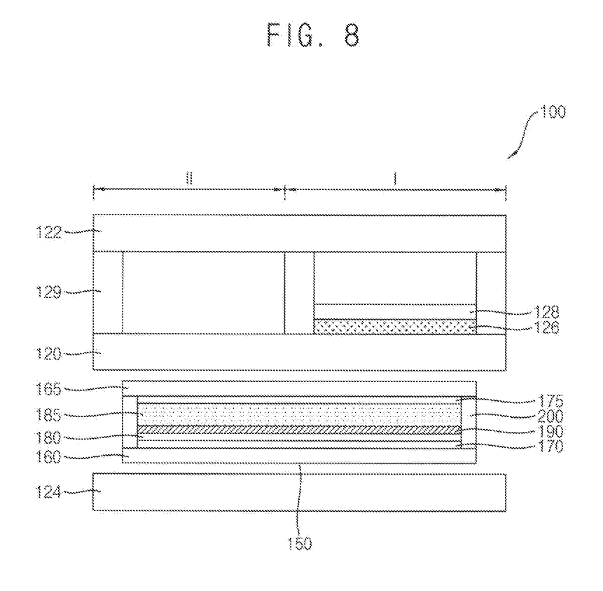

FIG. 8 is a cross-sectional view illustrating a display device in accordance with one embodiment. Referring to FIG. 8, the display device 100 includes a first substrate 120, a second substrate 122, a third substrate 124, a pixel circuit 126, a light emitting structure 128, a pixel defining layer 129, and a shielding member having a light shutter 150. Detailed description on elements of the display device 100 that are substantially the same as or similar to those illustrated with reference to FIG. 7 is omitted.

In one embodiment, the light shutter 150 may be disposed outside of the first substrate 120, for example, under the first substrate 120 as an on-cell structure. When the light shutter 150 is manufactured with the on-cell structure, the shielding member including the light shutter 150 may need to be separately manufactured in addition to the display device 100. In addition, the shielding member needs to be combined with the display device 100.

The third substrate 124 is disposed on the light shutter 150 to overlap the light shutter 150. The third substrate 124 may include a glass substrate or a resin substrate like the first and second substrate 120 and 122.

In one embodiment, the light shutter 150 is disposed to overlap the transparent area II and the display area I. Since the light shutter 150 overlaps the display area I as well as the transparent area II, the light shutter 150 may block most of light incident into the display area I and the transparent area II in the blocking mode, so that images on the display area I may be seen more clearly. Also, since the opaque organic solution 190 moves to the display area I in the blocking mode, light transmittance of the transparent area II increases.

As illustrated in FIG. 8, the shielding member including the light shutter 150 is disposed on a lower surface of the first substrate 120. When the light shutter 150 is disposed on the lower surface of the transparent area II, light emitted from the light emitting structure 128 may be blocked by the light shutter 150 disposed on the lower surface of the first substrate 120 in the blocking mode. In this case, the display device operates in a top emission mode.

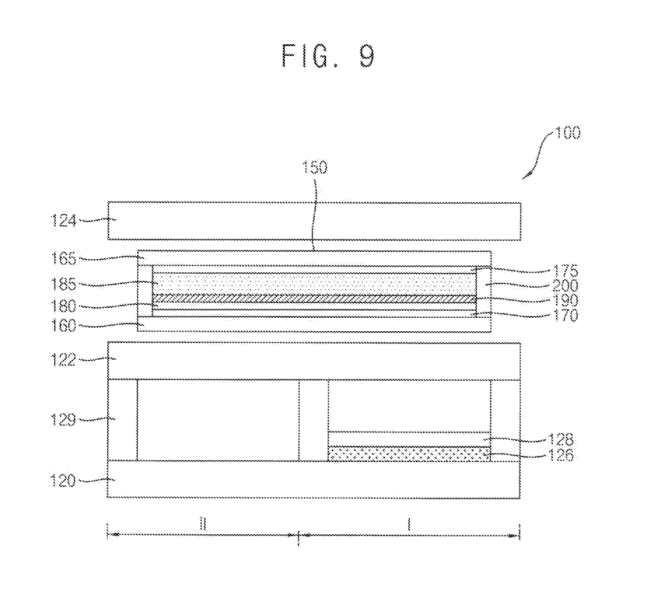

FIG. 9 is a cross-sectional view illustrating a display device in accordance with one embodiment. The display device 100 includes a first substrate 120, a second substrate 122, a third substrate 124, a pixel circuit 126, a light emitting structure 128, a pixel defining layer 129, and a shielding member having a light shutter 150. Detailed description on elements of the display device 100 that are substantially the same as or similar to those illustrated with reference to FIGS. 7 and 8 is omitted.

As illustrated in FIG. 9, the light shutter 150 overlaps a substantial portion of the display area I and the transparent area II and may be disposed outside of the second substrate 122. When the light shutter 150 is disposed outside of the second substrate 122, the light emitted from the light emitting structure 128 is blocked by the light shutter 150 in the blocking mode. In this case, the display device operates in a bottom emission mode.

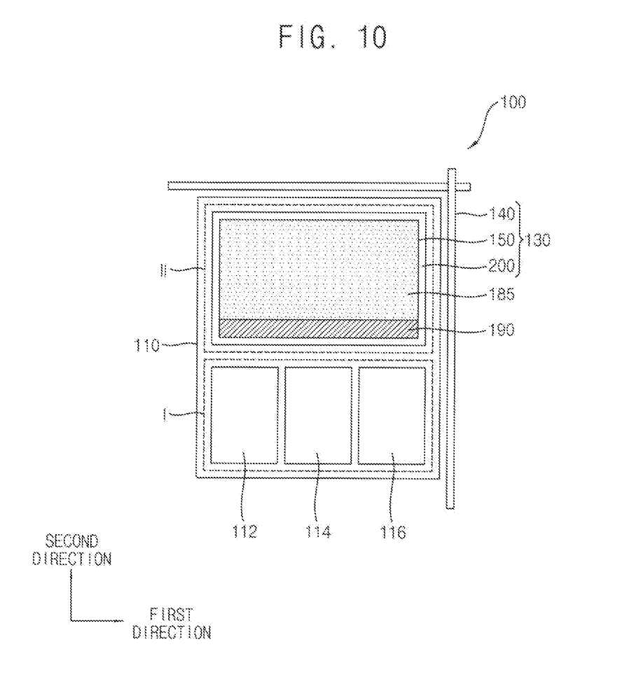

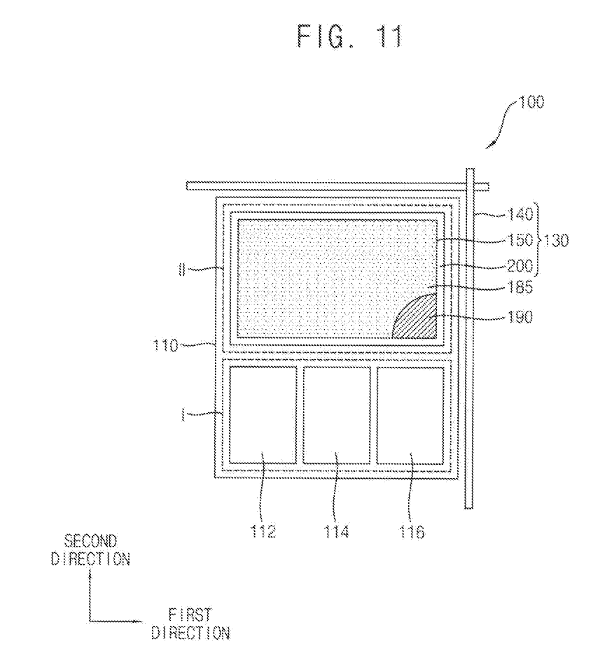

FIGS. 10 and 11 are planar views illustrating a display device in accordance with one embodiment. A shielding member 130 includes a light shutter line 140, a light shutter 150, and a wall 200. The light shutter 150 includes an aqueous solution 185, and an organic solution 190. In one embodiment, one side surface of the wall 200 of the shielding member 130 is substantially hydrophobic. When a voltage is applied to the light shutter 150, the organic solution 190 moves to a hydrophobic side surface of the wall 200 in a transparent mode.

As illustrated in FIG. 10, the hydrophobic side surface of the wall 200 is disposed along a side surface adjacent to the display area I. When the light shutter 150 is disposed outside of the first substrate (as shown in FIG. 8) or the second substrate (as shown in FIG. 9), and substantially overlaps the transparent area II and the display area I, the opaque organic solution 190 moves to the side surface adjacent the display area I, and the light incident into the transparent area II is transmitted in the transparent mode. As a result, the light transmittance of the display device 100 increases.

As illustrated in FIG. 11, the hydrophobic side edge of the wall 200 is disposed in a side edge area adjacent to the display area I. When the light shutter 150 is disposed outside of the first substrate (as shown in FIG. 8) or the second substrate (as shown in FIG. 9), and substantially overlaps all of the transparent area II and the display area I, the opaque organic solution 190 moves to the side edge area of the display area I, and the light incident into the transparent area II is transmitted in the transparent mode. As a result, the light transmittance of the display device 100 increases.

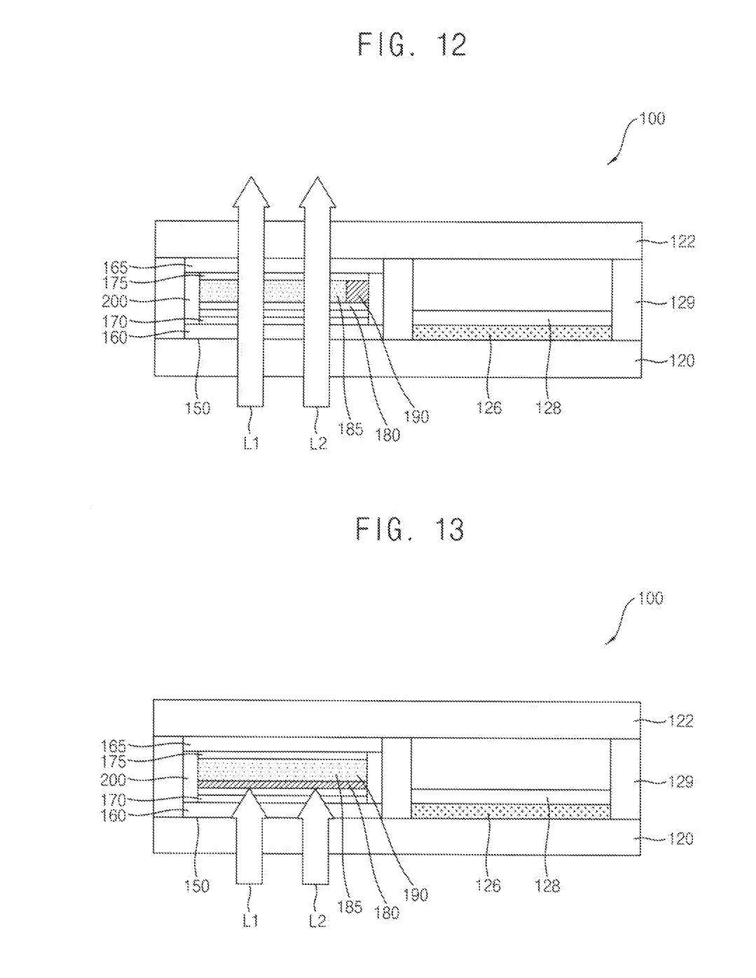

FIG. 12 is a cross-sectional view explaining a method of driving a display device in a transmissive mode in accordance with one embodiment. When the display device 100 is in a transparent mode, a voltage is applied between the lower electrode 170 and the upper electrode 175, and a surface of the insulating layer 180 changes from hydrophobic to hydrophilic. When the surface of the insulating layer 180 changes to hydrophilic, a contact area between the aqueous solution 185 and the insulating layer 180 increases. As a result, the transparent aqueous solution 185 covers a substantial portion of the transparent area, and light incident into the transparent area is transmitted.

In the transparent mode of the display device 100, as illustrated in FIG. 12, lights L1 and L2 incident through the first substrate 120 are substantially transmitted through the transparent area, so the display device 100 may function as a transparent display device.

FIG. 13 is a cross-sectional view explaining a method of driving a display device in a blocking mode in accordance with one embodiment. When the display device 100 is in a blocking mode, the voltage is not applied between the lower electrode 170 and the upper electrode 175, and the surface of the insulating layer 180 changes back to hydrophobic from hydrophilic. When the surface of the insulating layer 180 changes to hydrophobic, the contact area between the aqueous solution 185 and the insulating layer 180 decreases. As a result, the opaque organic solution 190 covers a substantial portion of the transparent area, and the light incident into the transparent area is blocked.

In the blocking mode of the display device 100, as illustrated in FIG. 13, the lights L1 and L2 incident through the first substrate 120 are blocked by the organic solution 190 covering a substantial portion of the transparent area, so the display device 100 may function as an opaque display device.

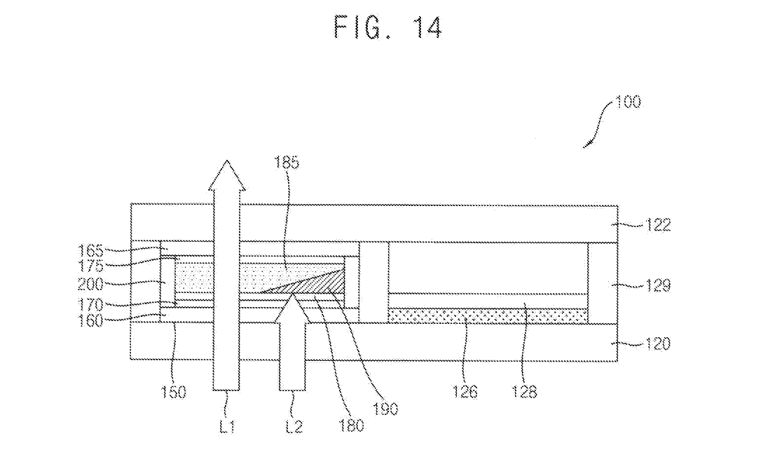

FIG. 14 is a cross-sectional view explaining a method of driving a display device in a transflective mode in accordance with one embodiment. When the display device 100 is in a transflective mode, a voltage less than a voltage in the transparent mode is applied between the lower electrode 170 and the upper electrode 175, and the surface of the insulating layer 180 changes from hydrophobic to relatively hydrophilic. When the surface of the insulating layer 180 changes to relatively hydrophilic, the contact area between the aqueous solution 185 and the insulating layer 180 increases, however the contact area may be less than that of the transparent mode shown in FIG. 12. Therefore, the opaque organic solution 190 may cover a partial portion of the transparent area, so light incident into the transparent area covered by the organic solution 190 is blocked, while light incident into the transparent area not covered by the organic solution 190 is transmitted.

In the transflective mode of the display device 100, as illustrated in FIG. 14, the light L1 incident into one part of the transparent area not covered by the organic solution 190 is transmitted, and the light L2 incident into the other part of the transparent area covered by the organic solution 190 is blocked. Therefore, the display device 100 may serve as a transparent display device of which transmittance may be controlled based on the voltage applied between the lower electrode 170 and the upper electrode 175.

As mentioned above, the light incident into the transparent area of the display device 100 may be transmitted, substantially blocked, or partially blocked by controlling the voltage applied between the lower electrode 170 and the upper electrode 175. The light shutter 150 disposed inside or outside of the transparent area may transmit, substantially block, or partially block the light incident into the transparent area, so that the transmittance of the display device 100 may be controlled.

Although some embodiments of the display devices and the method of driving the display devices have been described with reference to the figures, those skilled in the art will readily appreciate that many modifications are possible in the embodiments without materially departing from the novel teachings and advantages of the present disclosure.

The present disclosure may be applied to any electronic device including a display device. For example, the present disclosure may be applied to display devices for computers, notebooks, cellular phones, smart phones, smart pads, portable media players (PMPs), personal digital assistances (PDAs), MP3 players, digital cameras, video camcorders, etc.

The foregoing is illustrative of some embodiments and is not to be construed as limiting thereof. Although some embodiments have been described, those skilled in the art would readily appreciate that many modifications are possible without materially departing from the novel teachings and advantages of the present disclosure. Accordingly, such modifications are intended to be included within the scope of the present disclosure.

Therefore, it is to be understood that the foregoing is illustrative of various embodiments and is not to be construed as limited to the specific embodiments disclosed, and that modifications to the disclosed embodiments, as well as other embodiments, are intended to be included within the scope of the present disclosure.

What is claimed is:

1. A display device comprising:
a plurality of pixels including a display area and a transparent area; and
a shielding member having a light shutter, a light shutter line electrically connected to the light shutter and disposed adjacent to the plurality of pixels, and a wall surrounding the light shutter, the shielding member corresponding to the transparent area of each of the plurality of pixels,
wherein light transmittance of light incident into the transparent area is controlled by the shielding member.

2. The display device of claim 1, wherein the light shutter includes:
a lower substrate;
a lower electrode disposed on the lower substrate;
an insulating layer disposed on the lower electrode;
an upper substrate opposing the lower substrate;
an upper electrode disposed on a lower surface of the upper substrate; and
an organic solution and an aqueous solution interposed between the lower electrode and the upper electrode.

3. The display device of claim 2, wherein the organic solution includes a reflective material.

4. The display device of claim 1, wherein the light shutter transmits, substantially blocks, or partially blocks the light incident into the transparent area of each of the plurality of pixels.

5. The display device of claim 4, wherein the light shutter transmits the light incident into the transparent area when the display device operates in a transmissive mode.

6. The display device of claim 4, wherein the light shutter substantially blocks the light incident into the transparent area when the display device operates in a blocking mode.

7. The display device of claim 4, wherein the light shutter partially blocks the light incident into the transparent area when the display device operates in a transflective mode.

8. The display device of claim 1, further comprising:
a first substrate; and
a second substrate opposing the first substrate,
wherein the light shutter is interposed between the first and second substrates.

9. The display device of claim 1, further comprising:
a first substrate; and
a second substrate opposing the first substrate,
wherein the light shutter is disposed outside of the first substrate or the second substrate.

10. The display device of claim 9, wherein the light shutter overlaps both the transparent area and the display area.

11. The display device of claim 10, wherein the light shutter is disposed on a bottom of each of the plurality of pixels.

12. The display device of claim 10, wherein the light shutter is disposed on a top of each of the plurality of pixels.

13. The display device of claim 1, wherein one side surface of the wall is hydrophobic.

14. The display device of claim 13, wherein the one side surface of the wall is disposed adjacent to the display area.

15. The display device of claim 1, wherein one side edge of the wall is hydrophobic.

16. The display device of claim 15, wherein the one side edge of the wall is disposed adjacent to the display area.

17. A method of driving a display device comprising a plurality of pixels including a display area and a transparent area, and a shielding member having a light shutter, a light shutter line electrically connected to the light shutter and disposed adjacent to the plurality of pixels, and a wall surrounding the light shutter, the shielding member corresponding to the transparent area of each of the plurality of pixels, the method comprising:
applying a first voltage, a second voltage that is less than the first voltage, or a third voltage that is greater than the second voltage and less than the first voltage to the light shutter to selectively transmit, substantially block, or partially block light incident into the transparent area; and
operating the light shutter in a transmissive mode, a blocking mode, or a transflective mode.

18. The method of claim 17, wherein the first voltage is applied to the light shutter via the light shutter line to transmit the light incident into the transparent area when the light shutter operates in the transmissive mode.

19. The method of claim 17, wherein the second voltage is applied to the light shutter via the light shutter line to substantially block the light incident into the transparent area when the light shutter operates in the blocking mode.

20. The method of claim 17, wherein the third voltage is applied to the light shutter via the light shutter line to partially block the light incident into the transparent area when the light shutter operates in the transflective mode.
